(19) United States
(12) Patent Application Publication
(10) Pub. No.: US 2021/0112838 A1
(43) Pub. Date: Apr. 22, 2021

(54) UPSIDE DOWN OYSTERS

(71) Applicant: Zaire Humphrey, New Orleans, LA (US)

(72) Inventor: Zaire Humphrey, New Orleans, LA (US)

(21) Appl. No.: 16/657,914

(22) Filed: Oct. 18, 2019

(51) Int. Cl. A23L 17/50; A23L 5/10; A23B 4/06; A22C 29/04

(52) U.S. Cl. CPC A23L 17/50; A23L 5/13; A23V 2002/00; A22C 29/046; A22C 29/043; A23B 4/068

(57) ABSTRACT

The present disclosure provides for a method of preparing at least one oyster in a skillet. The at least one oyster is shucked to form a cupped-oyster on a half shell. The skillet is partially filled with a liquid solution, warmed to a temperature of at least 160° F., and the cupped-oyster is placed in the skillet upside down. The cupped-oyster is cooked for at least 2 minutes and then removed from the liquid solution. A method of preparing at least two dozen oysters in a roasting pan is presented. The at least two dozen oysters are shucked to form cupped-oysters on a half shell. The roasting pan is partially filled with a liquid solution, warmed to a temperature of at least 160° F., and the cupped-oysters are placed in the roasting pan upside down. The cupped-oysters are cooked for at least 3 minutes and then removed from the liquid solution.

### BACKGROUND OF THE INVENTION

### Field of the Invention

The present invention relates to a process of preparing cooked molluscan shellfish, such as bivalve mollusks, and more particularly to a process of cooking raw oysters in either a skillet or a roasting pan.

### Description of the Related Art

Raw oysters on the half shell are often considered a briny delicacy, however, raw seafood is not to everyone's taste. Oysters are a shellfish that are part of the Mollusca phylum, as such, oysters are known as mollusks. Mollusks comprise many shellfish, including clams and mussels. Oysters live in salty and brackish waters around the world, particularly in coastal regions of the Atlantic Ocean and Pacific Ocean. While, oysters are also classified as shellfish, they have no relation with the crustacean members of the shellfish classification. It is well known that oysters provide various health benefits and contain significant nutritional value. Oysters are particularly rich in vitamin B12, Omega-3 fatty acids, and mineral content. Vitamin B12 is an important component for maintaining healthy blood cells and nerves, it also plays an essential role in DNA synthesis. Every 100 grams of oysters contain approximately 324% of the reference daily intake (RDI) for vitamin B12. Omega-3 is an essential nutrient and therefore, is not naturally produced by humans and must be ingested as part of a healthy diet. Approximately 672 mg of omega-3 fatty acids are present for every 100 grams of oysters. Oysters offer a highly bioavailable and superior-quality source of protein and while every 100 grams of oysters only offer seven grams of protein, the per-calorie protein ratio rivals lean red meat for protein density; having only 68 calories per seven grams of protein. Oysters are the world's best dietary source of zinc, which plays a crucial role in immunity, protein and DNA synthesis, and general growth and development. One hundred grams of oysters provide approximately 491% of the RDI for zinc, or approximately 50% of the RDI per oyster. Oysters are an excellent source of vitamin D, which functions as a hormone rather than a traditional vitamin and promotes bone health, modulates cells, supports immune function, and decreases inflammation. Vitamin D is typically absorbed by the body through sunlight but may also be obtained from dietary sources, for example, 100 grams of oysters provide approximately 320 IU of vitamin D or 80% of the RDI. Oysters are also rich in copper, containing approximately 4.5 mg per 100 grams of oysters, which is approximately 223% of the RDI for copper. Copper is an essential mineral with several functions in the body, and is necessary for maintaining healthy bones, tissues, and organs.

One concern regarding oysters are for those with shellfish allergies, however, only about 14% of people are allergic to both crustaceans and mollusks. Another concern with consuming raw oysters is the possibility of contracting vibriosis infection from Vibrio bacteria contamination. Vibrio bacteria can grow in waters around the world and are more concentrated in warmer water and during the hottest periods of the year. Since oysters, like all mollusks, are benthic animals, they feed on the particles in their surrounding waters and can therefore become contaminated with Vibrio bacteria. In addition to Vibriosis, raw oysters can be a risk factor for certain other types of foodborne illnesses, such as, norovirus, hepatitis A, and Salmonella. While there are numerous safety procedures in place to avoid selling contaminated oysters to the public, the best way to minimize the risk of contracting these foodborne illnesses is by properly cooking oysters.

Currently, there are many ways of preparing oysters for consumption. Aside from eating raw oysters, oysters are often prepared utilizing several cooking methods. These methods include broiling or baking shucked oysters, frying shucked oysters on the half shell with the shell side down, poaching shucked oysters in fish stock or a mixture of water and lemon juice or wine with the shell side down, barbecuing shucked oysters on the half shell with the shell side down over high heat, and making oyster stew from shucked oysters, for example.

Over the years, various methods have been implemented for preparing oysters for human consumption. However, such commonly known methods are complex, time consuming, and limiting. There is a need for a simple, efficient, and time saving way of preparing cooked oysters.

A convention method for forming food products from mollusks is provided in U.S. Pat. No. 4,234,609 issued to Witte, which discloses a method of utilizing meat from mollusks, especially clam and oyster meat, along with isolated soy protein fibers. These ingredients are integrally bound by parboiling the meat, buffering the soy protein fibers, and mixing the two under agitation. Once mixed under agitation, the resulting formed mixture is then cooked to an internal temperature, which is effective to form a coherent protein matrix. Such methods are overly complex, time consuming and inconvenient to implement.

U.S. Pat. No. 3,594,860 issued to Nelson, et al. discloses an apparatus and method of mechanically shucking and eviscerating bivalve mollusks in a continuous, automatic process. The bivalve mollusks are shucked utilizing a burner to sever one half shell from the bivalve muscle, gaping the shell. The two half shells are then physically separated and the remaining half-shell, with the muscle and viscera attached, is inverted in a water bath. The viscera is loosened from the muscle and shell with water jet strikes and a suction pump ingests the viscera in a steadily flowing stream of water, thereby thoroughly eviscerating the bivalve. Another burner then severs the muscle from the remaining half shell. Such apparatuses and methods are complex and require specialized machinery or equipment.

U.S. Pat. No. 4,304,029 issued to Cox discloses an oyster processing method. The disclosed method utilizes a declustering component to break clusters of oysters into individual oysters and an opening component separates oyster half shells thereby exposing the meat of the oysters. The declustering component includes a rotatable drum containing a feed opening for oyster clusters and slots which permit only single oysters to leave the drum. The opening component includes mechanical means for disconnecting the oyster half shells by applying opposed shearing forces adjacent to the shell joint of the oysters. Such methods require complex machinery and are more suited for industrial mass production of processed oysters on the half shell.

Another method of shucking and eliminating bacteria from shellfish is disclosed in U.S. Pat. No. 6,537,601 B1 issued to Voisin. The disclosed invention relates to a process for eliminating pathogenic organisms and other bacteria from raw food products, such as raw shellfish, at temperatures in the range of between 50 and 130 degrees Fahrenheit, whereby the molluscan shellfish is exposed to hydrostatic pressure of relatively high value, for example between 10,000 p.s.i. to 60,000 p.s.i. for 1-15 minutes. However, such processes require complex and expensive equipment and is more suited for industrial mass production of processed raw molluscan shellfish.

More recently, U.S. Pat. No. 7,179,160 B2 issued to Hulin discloses a fully automated apparatus and system for processing shellfish such as shrimp and crawfish including cooking, drying, and peeling thereof. The disclosed apparatus and system also includes cooking the shellfish in a brine mix, which is transferred to a broth system to make seafood flavored broth and also injected as a fine mist into a furnace to be crystallized into a seafood flavored salt. Such apparatuses and systems require expensive complex machinery and are impractical for the preparation of cooked oysters.

While these methods, processes, and apparatuses may be suitable for the particular purposes employed, they would not be as suitable for the purposes of the present invention as disclosed hereafter.

Accordingly, there is a need for a simple, efficient, and time saving way of preparing cooked oysters in a skillet or a roasting pan.

As disclosed in this application, the inventor has discovered novel and unique devices and methods for efficient and simple cooked oyster preparation, which exhibit superlative properties without being dependent on complex, difficult, expensive, and time-consuming devices and methods.

Embodiments of the present invention provide for devices and methods and disclosed herein and as defined in the annexed claims which provide for improved preparation of cooked oyster features in order to efficiently, simply, and effectively serve as methods for cooking at least one oyster in a skillet and at least two dozen oysters in a roasting pan.

### SUMMARY OF THE INVENTION

It is one prospect of the present invention to provide one or more novel devices and methods of simple but effective construction and process which can be applied to many environments to efficiently, quickly, and effectively prepare cooked oysters.

The following presents a simplified summary of the present disclosure in a simplified form as a prelude to the more detailed description that is presented herein.

Therefore in accordance with embodiments of the invention, a novel method of cooking at least one oyster is provided. The method includes a step of shucking the at least one oyster while a cupped side is down by physically separating an oyster lid from an oyster cup, while preserving at least a part of a natural attachment between a muscle and the cup to form at least one cupped-oyster on a half-shell having an outer perimeter edge. The method includes providing a cooking skillet and a step of partially filling the cooking skillet with a liquid solution. The method includes a step of warming or heating the liquid solution until the solution's temperature is at least 160° F. Preferably, after warming or heating the liquid solution until the solution's temperature is at least 160° F., the method also includes a step of placing the at least one cupped-oyster upside down onto the cooking skillet, wherein the outer perimeter edge of the at least one cupped-oyster is submersed in the liquid solution. The method includes a step of warming or heating the liquid solution until the solution's temperature is at least 160° F. for at least 2 minutes while the outer perimeter edge of the upside down positioned at least one cupped-oyster is submerged in the liquid solution. After the at least 2 minutes, the method includes a step of removing from the liquid solution the upside down positioned at least one cupped-oyster as at least one cooked oyster.

In one embodiment, the method further includes an additional step of rinsing the at least one oyster with water prior to the step of shucking the at least one oyster.

In a preferred embodiment, the step of warming the liquid solution until the solution's temperature is at least 160° F. for at least 2 minutes is limited to no more than 3 minutes, while the outer perimeter edge of the at least one cupped-oyster, which is positioned upside down, is submerged in the liquid solution, such that the at least one cupped-oyster is removed from the liquid solution prior to the expiration of 3 minutes.

In one embodiment, the liquid solution is mixed or formed in a mixing bowl and then poured into the cooking skillet, prior to heating or warming the liquid solution in the cooking skillet. In another embodiment, the liquid solution is mixed or formed in the cooking skillet, prior to heating or warming the liquid solution in the cooking skillet.

In yet another embodiment, prior to heating or warming the liquid solution in the cooking skillet, the liquid solution includes at least 2 cups water, at least ⅓ cup of liquid crab boil, at least 2 teaspoons of salt, and at least ⅓ cup of butter. Preferably, prior to heating or warming the liquid solution in the cooking skillet, the liquid solution consists essentially of 2 cups water, ⅓ cup of liquid crab boil, 2 teaspoons of salt, and ⅓ cup of butter.

In one embodiment, the liquid solution further includes at least 2 drops of lemon juice, preferably prior to heating or warming the liquid solution in the cooking skillet.

In another embodiment, the liquid solution further includes at least 2 pinches of garlic, preferably prior to heating or warming the liquid solution in the cooking skillet.

In yet another embodiment, the method preferably further includes a step of placing at least 1 pinch of granulated crab boil onto the muscle of the at least one cooked oyster as a garnish, after the step of removing from the liquid solution the upside down positioned at least one cupped-oyster as the at least one cooked oyster.

In one embodiment, the method further includes a step of placing the at least one cooked oyster into a vacuum sealed package and flash-freezing the vacuum sealed package for retail.

In accordance with other embodiments of the invention, a cooked oyster product is provided. The cooked oyster product includes a cupped-oyster on a half shell having an outer perimeter edge. The cooked oyster product also includes a muscle of the cupped-oyster cooked upside down in a cooking skillet by submersion of the outer perimeter edge in a liquid solution having an elevated temperature of at least 160° F. for 2-3 minutes, wherein the muscle is exposed to a cooking surface of the cooking skillet while the outer perimeter edge of the cupped-oyster is submersed in the liquid solution for 2-3 minutes at the elevated temperature of the at least 160° F.

In a preferred embodiment, the liquid solution is infused into the muscle.

In another preferred embodiment, while the outer perimeter edge is submerged in the liquid solution, the liquid solution is warmed or heated until the solution's temperature is at least 160° F. for a time period of at least 2 minutes but no more than 3 minutes. Preferably, the outer perimeter edge is submerged in the liquid solution having the elevated temperature of the at least 160° F. for the time period of the at least 2 minutes.

In yet another embodiment, prior to heating or warming the liquid solution to the elevated temperature of at least 160° F. in the cooking skillet, the liquid solution includes at least 2 cups water, at least ⅓ cup of liquid crab boil, at least 2 teaspoons of salt, and at least ¼ cup of butter. Preferably, prior to heating or warming the liquid solution to the elevated temperature of at least 160° F. in the cooking skillet, the liquid solution consists essentially of 2 cups water, ⅓ cup of liquid crab boil, 2 teaspoons of salt, and ⅓ cup of butter.

In yet another embodiment, the liquid solution further includes at least 2 drops of lemon juice, preferably prior to heating or warming the liquid solution to the elevated temperature of at least 160° F. in the cooking skillet.

In one embodiment, the liquid solution further includes at least 2 pinches of garlic, preferably prior to heating or warming the liquid solution to the elevated temperature of at least 160° F. in the cooking skillet.

In another embodiment, the cooked oyster product further includes at least 1 pinch of granulated crab boil placed onto the muscle after removal of the cupped-oyster from the cooking skillet.

In yet another embodiment, the cooked oyster product is vacuum sealed in a vacuum sealed package and flash-frozen for retail.

Therefore in accordance with embodiments of the invention, a novel method of cooking at least two dozen oysters is presented. The method includes a step of shucking each oyster of the at least two dozen oysters while a cupped side is down by physically separating each oyster lid from each oyster cup while preserving at least a part of a natural attachment between a muscle and the cup of each oyster of the at least two dozen oysters to form at least two dozen cupped-oysters on a half-shell with each oyster having an outer perimeter edge. The method includes providing a roasting pan and a step of partially filling the roasting pan with a liquid solution. The method includes a step of warming or heating the liquid solution until the solution's temperature is at least 160° F. Preferably, after warming or heating the liquid solution until the solution's temperature is at least 160° F., the method also includes a step of placing the at least two dozen cupped-oysters upside down onto the roasting pan, wherein each oyster's outer perimeter edge of the at least two dozen cupped-oysters is submersed in the liquid solution. The method includes a step of warming the liquid solution until the solution's temperature is at least 160° F. for at least 3 minutes while each oyster's outer perimeter edge of the upside down positioned at least two dozen cupped-oysters is submerged in the liquid solution. After the at least 3 minutes, the method further includes a step of removing from the liquid solution the upside down positioned at least two dozen cupped-oysters as at least two dozen cooked oysters.

In one embodiment, the method further includes an additional step of rinsing the at least two dozen oysters with water prior to the step of shucking the at least two dozen oysters.

In a preferred embodiment, the step of warming the liquid solution until the solution's temperature is at least 160° F. for at least 3 minutes is limited to no more than 5 minutes, while each oyster's outer perimeter edge of the at least two dozen cupped-oysters, which is positioned upside down, is submerged in the liquid solution, such that the at least two dozen cupped-oysters are removed from the liquid solution prior to the expiration of 5 minutes.

In one embodiment, the liquid solution is mixed or formed in a mixing bowl and then poured into the roasting pan, prior to heating or warming the liquid solution in the roasting pan. In another embodiment, the liquid solution is mixed or formed in the roasting pan, prior to heating or warming the liquid solution in the roasting pan.

In yet another embodiment, prior to heating or warming the liquid solution in the roasting pan, the liquid solution includes at least 4 cups water, at least ⅔ cup of liquid crab boil, at least 4 teaspoons of salt, and at least ⅔ cup of butter. Preferably, prior to heating or warming the liquid solution in the roasting pan, the liquid solution consists essentially of 4 cups water, ⅔ cup of liquid crab boil, 4 teaspoons of salt, and ⅔ cup of butter.

In one embodiment, the liquid solution further includes at least 4 drops of lemon juice, preferably prior to heating or warming the liquid solution in the roasting pan.

In another embodiment, the liquid solution further includes at least 4 pinches of garlic, preferably prior to heating or warming the liquid solution in the roasting pan.

In yet another embodiment, the method preferably further includes a step of placing at least 1 pinch of granulated crab boil onto the muscle of each of the at least two dozen cooked oysters as a garnish, after the step of removing from the liquid solution the upside down positioned at least two dozen cupped-oysters as the at least two dozen cooked oysters.

In one embodiment, the method further includes a step of placing at least a portion of the at least two dozen cooked oysters into a vacuum sealed package and flash-freezing the vacuum sealed package for retail.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a top left perspective view of oysters, in accordance with embodiments of the invention;

FIG. 2 is a top perspective view of an oyster being shucked, in accordance with embodiments of the invention;

FIG. 3 is a side elevation view of a shucked oyster, in accordance with embodiments of the invention;

FIG. 4 is a top view of a liquid solution in a skillet, in accordance with embodiments of the invention;

FIG. 5 is a top front perspective view of cupped-oysters on a half shell submersed in a liquid solution in a skillet, in accordance with embodiments of the invention;

FIG. 6 is a front elevation view in partial cut away of an exemplary cupped-oyster on a half shell submersed in a liquid solution in a skillet, in accordance with embodiments of the invention;

FIG. 7 is a top view of cooked oysters removed from a liquid solution, in accordance with embodiments of the invention;

FIG. 8 is a top view of cooked oysters in a vacuum sealed package, in accordance with embodiments of the invention;

FIG. 9 is an exemplary flowchart illustrating an exemplary method of cooking at least one oyster, in accordance with embodiments of the invention;

FIG. 10 is a top left perspective view of a liquid solution in a skillet, in accordance with embodiments of the invention;

FIG. 11 is a top left perspective view of cupped-oysters on a half shell submersed in a liquid solution in a roasting pan, in accordance with embodiments of the invention; and

FIG. 12 is an exemplary flowchart illustrating an exemplary method of cooking at least two dozen oysters, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

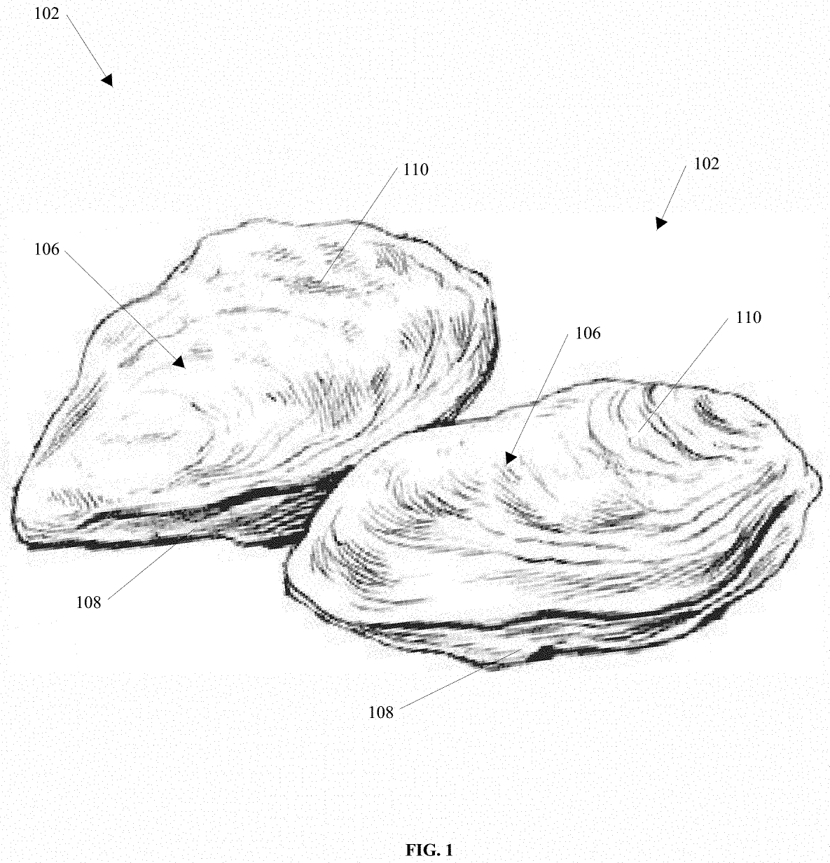

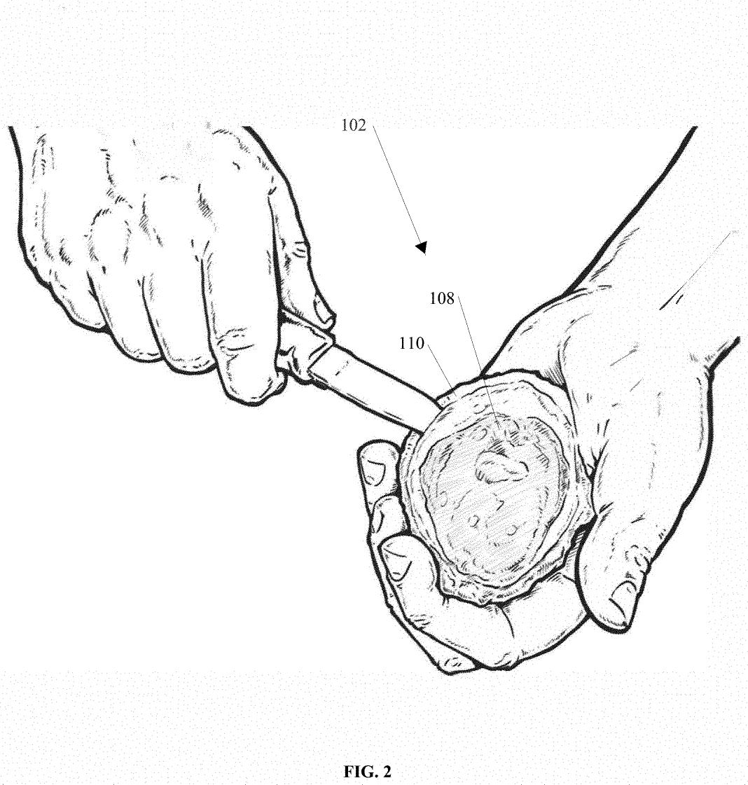

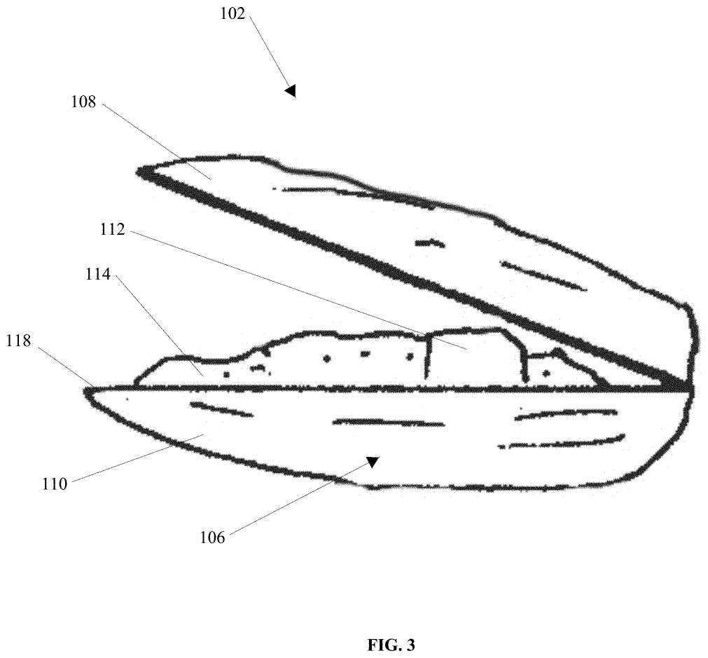

Referring initially to FIGS. 1-9, the basic constructional details and principles of operation of embodiments of upside down cooked oysters according to a preferred embodiment of the present invention will be discussed.

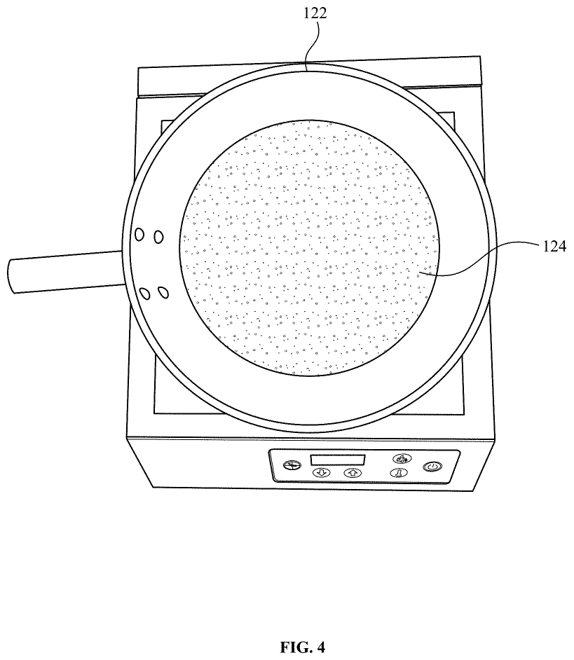

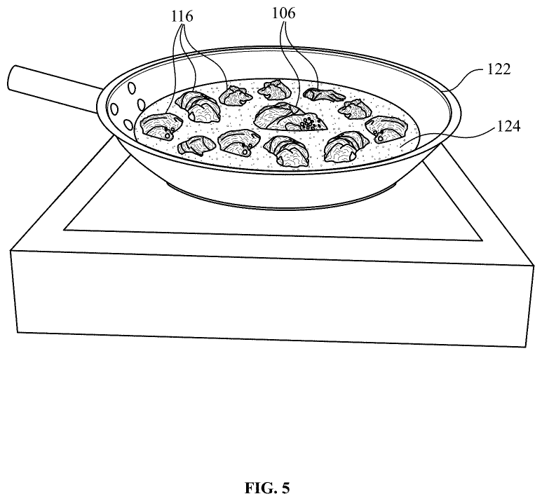

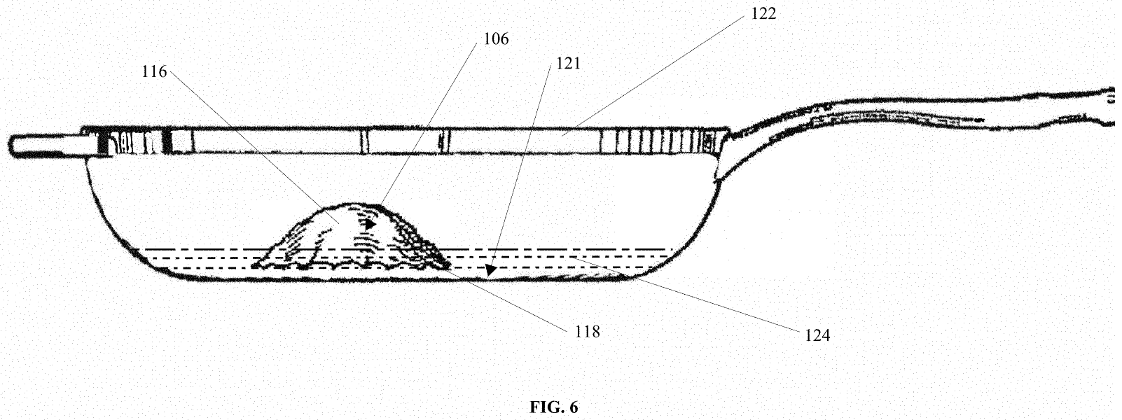

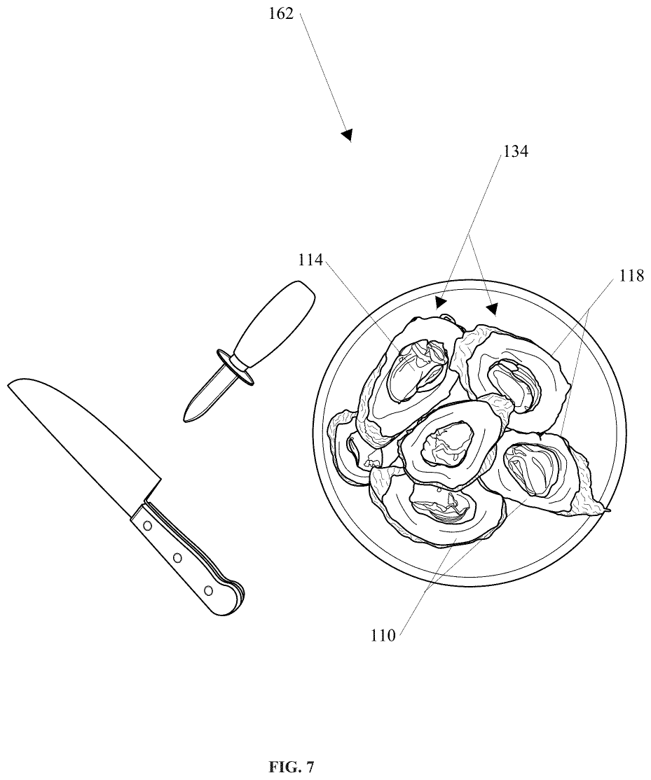

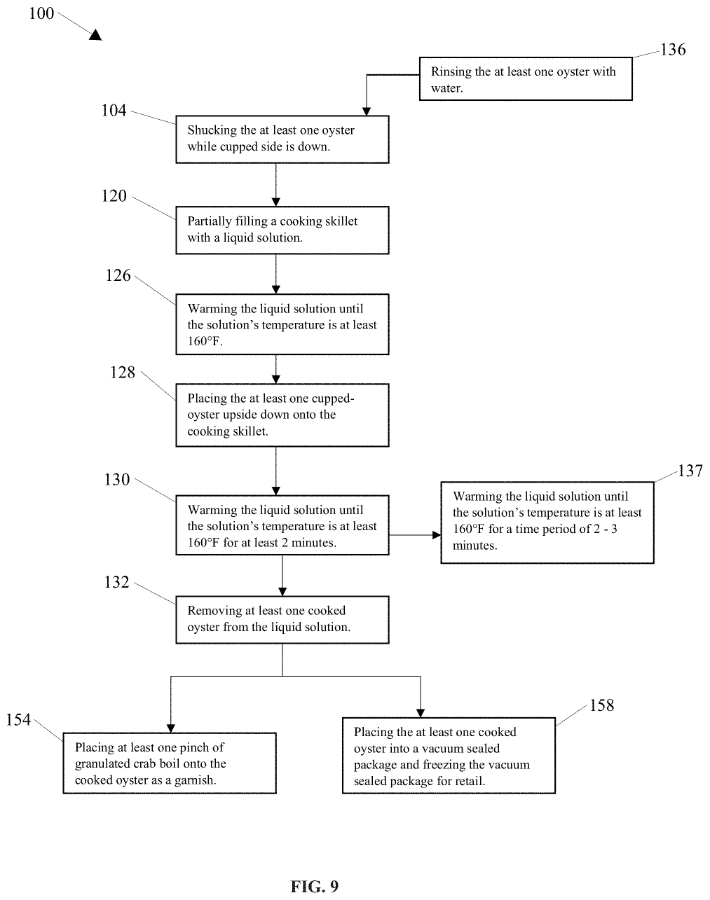

Therefore in accordance with embodiments of the invention, a novel method 100 of cooking at least one oyster 102 is provided, as illustrated in FIG. 9. As illustrated in FIGS. 1-3, the method 100 includes a step (a) 104 of shucking the at least one oyster 102 while a cupped side 106 is down by physically separating an oyster lid 108 from an oyster cup 110, while preserving at least a part of a natural attachment 112 between a muscle 114 and the cup 110 to form at least one cupped-oyster on a half-shell 116 having an outer perimeter edge 118. As illustrated in FIG. 4, the method 100 includes providing a cooking skillet 122 and a step (b) 120 of partially filling the cooking skillet 122 with a liquid solution 124. The method 100 includes a step (c) 126 of warming or heating the liquid solution 124 until the solution's temperature is at least 160° F. Preferably, after warming or heating the liquid solution 124 until the solution's temperature is at least 160° F., as shown in FIGS. 5-6, the method 100 includes a step (d) 128 of placing the at least one cupped-oyster 116 upside down onto the cooking skillet 122, wherein the outer perimeter edge 118 of the at least one cupped-oyster 116 is submersed in the liquid solution 124. The method 100 includes a step (e) 130 of warming or heating the liquid solution 124 until the solution's temperature is at least 160° F. for at least 2 minutes while the outer perimeter edge 118 of the upside down positioned at least one cupped-oyster 116 is submerged in the liquid solution 124. After the at least 2 minutes, the method 100 includes a step (f) 132 of removing from the liquid solution 124 the upside down positioned at least one cupped-oyster 116 as at least one cooked oyster 134, as shown in FIG. 7.

In one embodiment, as shown in FIG. 9, the method 100 further includes an additional step (g) 136 of rinsing the at least one oyster 102 with water prior to the step (a) 104 of shucking the at least one oyster 102.

In a preferred embodiment, the step (e) 130 further includes a step (h) 250 of warming the liquid solution 124 until the solution's temperature is at least 160° F. for at least 2 minutes is limited to no more than 3 minutes, while the outer perimeter edge 118 of the at least one cupped-oyster 116, which is positioned upside down, is submerged in the liquid solution 124, such that the at least one cupped-oyster 116 is removed from the liquid solution 124 prior to the expiration of 3 minutes as shown in FIG. 9. Preferably, step (e) 130 further comprises exposing a muscle 114 of the at least one cupped-oyster 116 to a cooking surface 121 of the cooking skillet 122 while the outer perimeter edge 118 of the cupped-oyster 116 is submersed in the liquid solution 124 for 2-3 minutes at elevated temperature of the at least 160° F.

In one embodiment, the liquid solution 124 is mixed or formed in a mixing bowl and then poured into the cooking skillet 122, prior to heating or warming the liquid solution 124 in the cooking skillet 122. In another embodiment, the liquid solution 124 is mixed or formed in the cooking skillet 122, prior to heating or warming the liquid solution 124 in the cooking skillet 122.

In yet another embodiment, as shown in FIG. 9, prior to heating or warming the liquid solution 124 in the cooking skillet 122, the liquid solution 124 includes at least 2 cups water, at least ¼ cup of liquid crab boil, at least 2 teaspoons of salt, and at least ¼ cup of butter. Preferably, prior to heating or warming the liquid solution 124 in the cooking skillet 122, the liquid solution 124 consists essentially of 2 cups water, ¼ cup of liquid crab boil, 2 teaspoons of salt, and ¼ cup of butter.

In one embodiment, the liquid solution 124 further includes at least 2 drops of lemon juice 150, as shown in FIG. 9, preferably prior to heating or warming the liquid solution 124 in the cooking skillet 122.

In another embodiment, the liquid solution 124 further includes at least 2 pinches of garlic 152, as shown in FIG. 9, preferably prior to heating or warming the liquid solution 124 in the cooking skillet 122.

In yet another embodiment, the method 100 further includes a step (i) 154 of placing at least 1 pinch of granulated crab boil 156 onto the at least one cooked oyster 134 as a garnish, after the step (f) 132 of removing from the liquid solution 124 the upside down positioned at least one cupped-oyster 116 as the at least one cooked oyster 134, as illustrated in FIGS. 7 and 9.

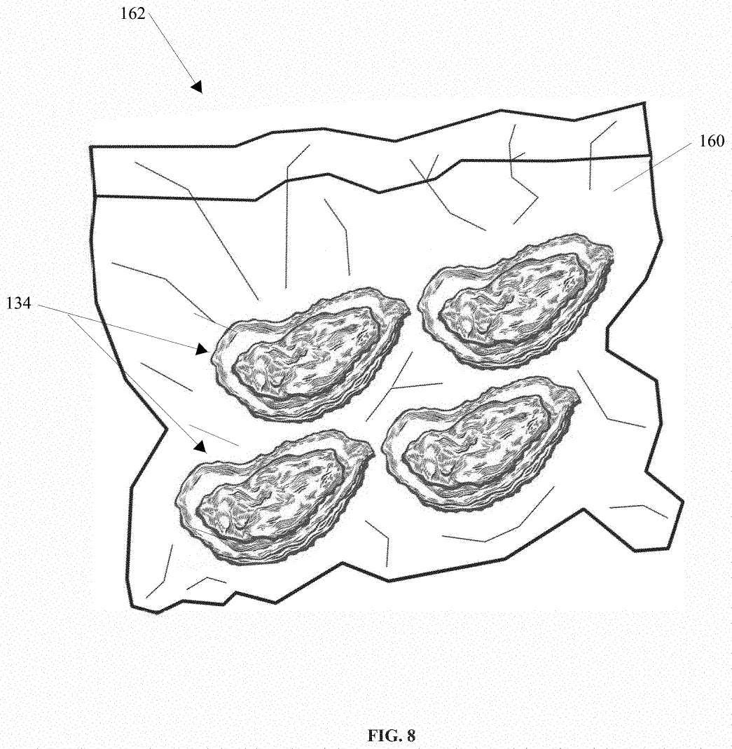

In one embodiment, as illustrated in FIGS. 8-9, the method 100 further includes a step (j) 158 of placing the at least one cooked oyster 134 into a vacuum sealed package 160 and flash-freezing the vacuum sealed package 160 for retail.

In accordance with other embodiments of the invention, a cooked oyster product 162 is provided, as illustrated in FIGS. 1-8. As illustrated in FIGS. 1-3, the cooked oyster product 162 includes a cupped-oyster on a half shell 134 having an outer perimeter edge 118. The cooked oyster product 162 also includes a muscle 114 of the cupped-oyster 134 cooked upside down in a cooking skillet 122 by submersion of the outer perimeter edge 118 in a liquid solution 124, as illustrated in FIGS. 5-6, having an elevated temperature of at least 160° F. for 2-3 minutes, wherein the muscle 114 is exposed to a cooking surface 121 of the cooking skillet 122 while the outer perimeter edge 118 of the cupped-oyster 134 is submersed in the liquid solution 124 for 2-3 minutes at the elevated temperature of the at least 160° F.

In a preferred embodiment, the liquid solution 124 is infused into the muscle 114.

In another preferred embodiment, while the outer perimeter edge 118 is submerged in the liquid solution 124, the liquid solution 124 is warmed or heated until the solution's temperature is at least 160° F. for a time period of at least 2 minutes but no more than 3 minutes. Preferably, the outer perimeter edge 118 is submerged in the liquid solution 124 having the elevated temperature of the at least 160° F. for the time period of the at least 2 minutes.

In yet another embodiment, prior to heating or warming the liquid solution 124 to the elevated temperature of at least 160° F. in the cooking skillet 122, the liquid solution 124 includes at least 2 cups water, at least ¼ cup of liquid crab boil, at least 2 teaspoons of salt, and at least ¼ cup of butter. Preferably, prior to heating or warming the liquid solution 124 to the elevated temperature of at least 160° F. in the cooking skillet 122, the liquid solution 124 consists essentially of 2 cups water, ¼ cup of liquid crab boil, 2 teaspoons of salt, and ¼ cup of butter.

In yet another embodiment, the liquid solution 124 further includes at least 2 drops of lemon juice, preferably prior to heating or warming the liquid solution 124 to the elevated temperature of at least 160° F. in the cooking skillet 122.

In one embodiment, the liquid solution 124 further includes at least 2 pinches of garlic, preferably prior to heating or warming the liquid solution 124 to the elevated temperature of at least 160° F. in the cooking skillet 122.

In another embodiment, the cooked oyster product 162 further includes at least 1 pinch of granulated crab boil 156 placed onto the muscle 114 after removal of the cupped-oyster 134 from the cooking skillet 122, as illustrated in FIG. 7.

In yet another embodiment, the cooked oyster product 162 is vacuum sealed in a vacuum sealed package 160 and flash-frozen for retail, as illustrated in FIG. 8.

Referring to FIGS. 8 and 10-12, the basic constructional details and principles of operation of embodiments of upside down cooked oysters according to a preferred embodiment of the present invention will be discussed.

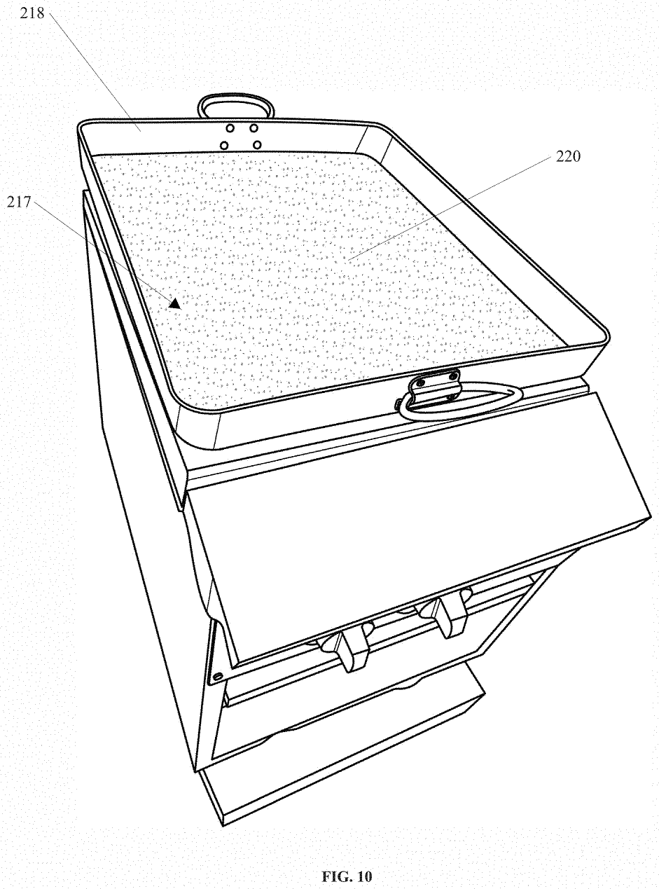

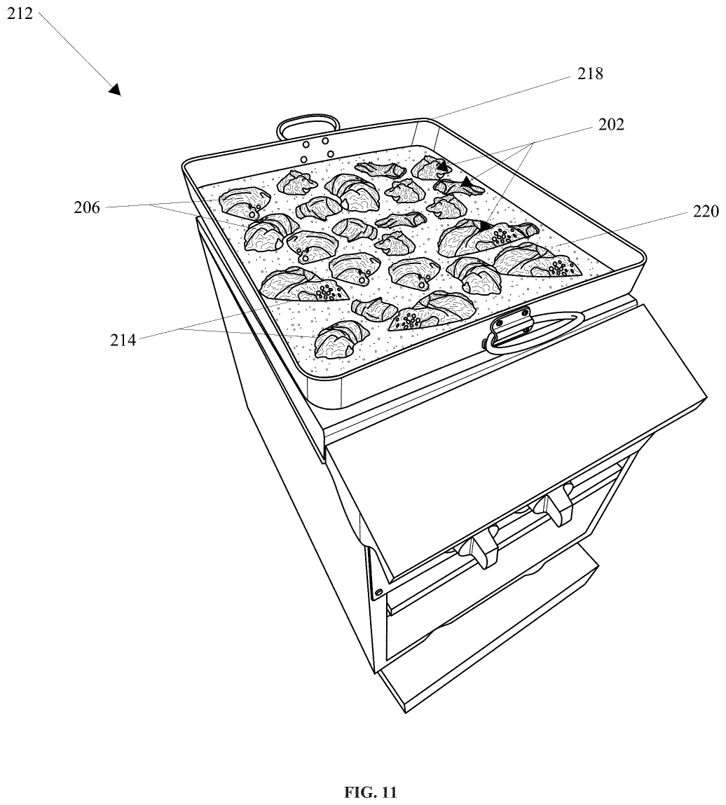

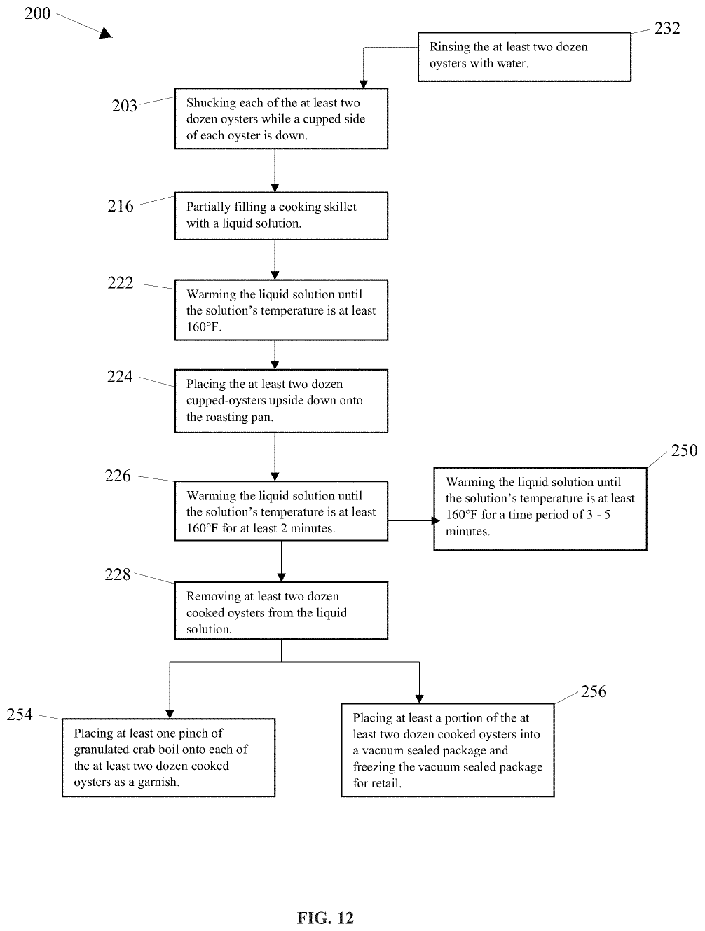

Therefore in accordance with embodiments of the invention, as illustrated in FIG. 12, a novel method 200 of cooking at least two dozen oysters 201 is presented. The method 200 includes a step (a¹) 203 of shucking each oyster of the at least two dozen oysters 201 while a cupped side 202 of each oyster of the at least two dozen oysters 201 is down by physically separating each oyster lid 204 from each oyster cup 206 while preserving at least a part of a natural attachment 208 between a muscle 210 and each oyster cup 206 of each oyster of the at least two dozen oysters 201 to form at least two dozen cupped-oysters on a half-shell 212 with each having an outer perimeter edge 214, as illustrated in FIG. 12. The method 200 includes providing a roasting pan 218 and a step (b¹) 216 of partially filling the roasting pan 218 with a liquid solution 220, as illustrated in FIG. 10. The method 200 includes a step (c¹) 222 of warming or heating the liquid solution 220 until the solution's temperature is at least 160° F. Preferably, after warming or heating the liquid solution 220 until the solution's temperature is at least 160° F., the method 200 includes a step (d¹) 224 of placing the at least two dozen cupped-oysters 212 upside down onto the roasting pan 218, as illustrated in FIG. 11, wherein each oyster's outer perimeter edge 214 of the at least two dozen cupped-oysters 212 is submersed in the liquid solution 220. The method 200 includes a step (e¹) 226 of warming or heating the liquid solution 220 until the solution's temperature is at least 160° F. for at least 3 minutes while each oyster's outer perimeter edge 214 of the upside down positioned at least two dozen cupped-oysters 212 is submerged in the liquid solution 220. After the at least 3 minutes, the method 200 further includes a step (f¹) 228 of removing from the liquid solution 220 the upside down positioned at least two dozen cupped-oysters 212 as at least two dozen cooked oysters 230.

In one embodiment, as illustrated in FIG. 12, the method 200 further includes a step (g¹) 232 of rinsing the at least two dozen oysters 201 with water prior to the step (a¹) 203 shucking each of the at least two dozen oysters 201.

In a preferred embodiment, step (e¹) 226 further includes a step (h¹) 250 of warming the liquid solution 220 until the solution's temperature is at least 160° F. for at least 3 minutes is limited to no more than 5 minutes, while each oyster's outer perimeter edge 214 of the at least two dozen cupped-oysters 212, which is positioned upside down, is submerged in the liquid solution 220, such that the at least two dozen cupped-oysters 212 are removed from the liquid solution 220 prior to the expiration of 5 minutes. Preferably, step (e¹) 226 further comprises exposing the muscle 210 of the at least two dozen cupped-oysters 212 to a cooking surface 217 of the roasting pan 218 while each oyster's outer perimeter edge 214 of the at least two dozen cupped-oysters 212 is submersed in the liquid solution 220 for 3-5 minutes at elevated temperature of the at least 160° F.

In one embodiment, the liquid solution 220 is mixed or formed in a mixing bowl and then poured into the roasting pan 218, prior to heating or warming the liquid solution 220 in the roasting pan 218. In another embodiment, the liquid solution 220 is mixed or formed in the roasting pan 218, prior to heating or warming the liquid solution 220 in the roasting pan 218.

In yet another embodiment, as shown in FIG. 12, prior to heating or warming the liquid solution 220 in the roasting pan 218, the liquid solution 220 includes at least 4 cups water, at least ⅔ cup of liquid crab boil, at least 4 teaspoons of salt, and at least ⅔ cup of butter. Preferably, prior to heating or warming the liquid solution 220 in the roasting pan 218, the liquid solution 220 consists essentially of 4 cups water, ⅔ cup of liquid crab boil, 4 teaspoons of salt, and ⅔ cup of butter.

In one embodiment, the liquid solution 220 further includes at least 4 drops of lemon juice, preferably prior to heating or warming the liquid solution 220 in the roasting pan 218.

In another embodiment, the liquid solution 220 further includes at least 4 pinches of garlic, preferably prior to heating or warming the liquid solution 220 in the roasting pan 218.

In yet another embodiment, the method 200 includes a step (i¹) 254 of placing at least 1 pinch of granulated crab boil 156 onto the muscle 210 of each of the at least two dozen cooked oysters 230 as a garnish, after the step (f¹) 228 of removing from the liquid solution 220 the upside down positioned at least two dozen cupped-oysters 212 as the at least two dozen cooked oysters 230.

In one embodiment, the method 200 further includes a step (j¹) 256 of placing at least a portion 134 of the at least two dozen cooked oysters 230 into a vacuum sealed package 160 and flash-freezing the vacuum sealed package 160 for retail, as illustrated in FIGS. 8 and 12.

All U.S. patents and publications identified herein are incorporated in their entirety by reference thereto.

The claimed invention is:

1. A method of cooking at least one oyster comprising:
(a) shucking the at least one oyster while cupped side is down by physically separating an oyster lid from an oyster cup while preserving at least a part of a natural attachment between a muscle and the cup to form a cupped-oyster on a half-shell having an outer perimeter edge;
(b) partially filling a cooking skillet with a liquid solution;
(c) warming or heating the liquid solution until the solution's temperature is at least 160° F.;
(d) placing the at least one cupped-oyster upside down onto the cooking skillet, wherein said outer perimeter edge of the cupped-oyster is submersed in the liquid solution;
(e) warming or heating the liquid solution until the solution's temperature is at least 160° F. for at least 2 minutes while said outer perimeter edge is submerged in said liquid solution; and
(f) removing from said liquid solution the at least one cupped-oyster as at least one cooked oyster.

2. The method of claim 1, further comprising a step (g) of rinsing said cupped-oyster with water prior to the step (a) of shucking the at least one oyster.

3. The method of claim 1, wherein step (e) further comprises a step (h) of warming the liquid solution until the solution's temperature is at least 160° F. for a time period of 2-3 minutes while said outer perimeter edge is submerged in said liquid solution.

4. The method of claim 1, wherein the liquid solution comprises at least 2 cups water, at least ¼ cup of liquid crab boil, at least 2 teaspoons of salt, and at least ¼ cup of butter.

5. The method of claim 3, wherein the liquid solution further comprises at least 2 drops of lemon juice.

6. The method of claim 3, wherein the liquid solution further comprises at least 2 pinches of garlic.

7. The method of claim 1, further comprising a step (i) of placing at least one pinch of granulated crab boil onto the muscle of the at least one cooked oyster as a garnish after the step (f) of removing from the liquid solution the at least one cupped-oyster as the at least one cooked oyster.

8. The method of claim 1, further comprising a step (j) of placing the at least one cooked oyster into a vacuum sealed package and flash-freezing the vacuum sealed package.

9. The method of claim 1, wherein step (e) further comprises exposing the muscle of the at least one cupped-oyster to a cooking surface of the cooking skillet while the outer perimeter edge of the cupped-oyster is submersed in the liquid solution for 2-3 minutes at elevated temperature of the at least 160° F.

10. A cooked oyster product which comprises:
a cupped-oyster on a half shell having an outer perimeter edge;
a muscle of the cupped-oyster cooked upside down in a cooking skillet by submersion of the outer perimeter edge in a liquid solution having an elevated temperature of at least 160° F. for 2-3 minutes, wherein said muscle is exposed to a cooking surface of the cooking skillet while the outer perimeter edge of the cupped-oyster is submersed in the liquid solution for 2-3 minutes at said elevated temperature of the at least 160° F.

11. The cooked oyster product of claim 10, wherein said liquid solution is infused into said muscle.

12. The cooked oyster product of claim 10, wherein the liquid solution comprises at least 2 cups water, at least ¼ cup of liquid crab boil, at least 2 teaspoons of salt, and at least ¼ cup of butter.

13. The cooked oyster product of claim 12, wherein the liquid solution further comprises at least 2 drops of lemon juice.

14. The cooked oyster product of claim 12, wherein the liquid solution further comprises at least 2 pinches of garlic.

15. The cooked oyster product of claim 10, further comprising at least 1 pinch of granulated crab boil placed onto the muscle after removal of the cupped-oyster from the cooking skillet.

16. The cooked oyster product of claim 10, wherein said product is vacuum sealed in a vacuum sealed package and flash-frozen.

17. A method of cooking at least two dozen oysters comprising:
(a) shucking each oyster of the at least two dozen oysters while a cupped side of each oyster of the at least two dozen oysters is down by physically separating each oyster lid from each oyster cup while preserving at least a part of a natural attachment between a muscle and each oyster cup of each oyster of the at least two dozen oysters to form at least two dozen cupped-oysters on a half-shell, each having an outer perimeter edge;
(b) partially filling a roasting pan with a liquid solution;
(c) warming or heating the liquid solution until the solution's temperature is at least 160° F.;
(d) placing the at least two dozen cupped-oysters upside down onto the roasting pan, wherein each oyster's outer perimeter edge of the at least two dozen cupped-oysters is submersed in the liquid solution;
(e) warming or heating the liquid solution until the solution's temperature is at least 160° F. for at least 3 minutes while each oyster's outer perimeter edge is submerged in said liquid solution; and
(f) removing from said liquid solution the upside down positioned at least two dozen cupped-oysters as at least two dozen cooked oysters.

18. The method of claim 17, further comprising a step (g¹) of rinsing said at least two dozen oysters with water prior to the step (a¹) of shucking each of the at least two dozen oysters.

19. The method of claim 17, wherein step (e¹) further comprises a step (h¹) of warming the liquid solution until the solution's temperature is at least 160° F. for a time period of 3-5 minutes while said each oyster's outer perimeter edge is submerged in said liquid solution.

20. The method of claim 17, wherein the liquid solution comprises at least 4 cups water, at least ⅔ cup of liquid crab boil, at least 4 teaspoons of salt, and at least ⅔ cup of butter.

21. The method of claim 20, wherein the liquid solution further comprises at least 4 drops of lemon juice.

22. The method of claim 20, wherein the liquid solution further comprises at least 4 pinches of garlic.

23. The method of claim 17, further comprising a step (i¹) of placing at least one pinch of granulated crab boil onto the muscles of each of the at least two dozen cooked oysters as a garnish after the step (f¹) of removing from the liquid solution the upside down positioned at least two dozen cupped-oysters as the at least two dozen cooked oysters.

24. The method of claim 17, further comprising a step (j¹) of placing at least a portion of the at least two dozen cooked oysters into a vacuum sealed package and flash-freezing the vacuum sealed package.

25. The method of claim 17, wherein step (e¹) further comprises exposing the muscle of each oyster of the at least two dozen cupped-oysters to a cooking surface of the roasting pan while the outer perimeter edge of each oyster of the at least two dozen cupped-oysters is submersed in the liquid solution for 3-5 minutes at elevated temperature of the at least 160° F.
